(19) United States
(12) Patent Application Publication
(10) Pub. No.: US 2011/0260017 A1
(43) Pub. Date: Oct. 27, 2011

(54) Adjustable Support Arm

(75) Inventors: Fabian A. Monsalve, Brooklyn, NY (US); Sergio Silva, Brooklyn, NY (US); Mark McKenna, New York, NY (US); Emilian Dan Cartis, Brooklyn, NY (US)

(73) Assignee: HUMANSCALE CORPORATION, New York, NY (US)

(21) Appl. No.: 12/766,561

(22) Filed: Apr. 23, 2010

(51) Int. Cl. F16M 13/00

(52) U.S. Cl. 248/201

(57) ABSTRACT

An adjustable support arm utilizing a spring having a dynamic attachment point to support the weight of an attached object. The adjustable support arm can comprise a lower bracket connected to an upper bracket by a parallelogram linkage. A spring is utilized to counterbalance the weight of an attached object. The first end of the spring can be attached to the upper link of the parallelogram linkage. The second end of the spring is attached to a drag link to provide a dynamic attachment point that automatically adjusts as the support arm is moved between the upper and lower vertical positions. Either a pivot link or a slot in the lower link can be used to guide the drag link's movement as the support arm's vertical height is adjusted.

### I. BACKGROUND

The present invention relates to mounting systems for objects such as a flat panel displays, light sources, or work surfaces. Current-generation adjustable support arms typically utilize a gas cylinder to counterbalance the weight of the attached object. However, in addition to being heavy and bulky, the gas cylinders are failure-prone. The gas cylinders inevitably leak gas and lose pressure and therefore have a limited lifespan.

Mechanical springs have been used as an alternative to gas cylinders in prior art parallelogram support arms. However, mechanical springs present their own performance issues. Typically, one end of the spring is attached to the upper link of the support arm, while the second end of the spring is attached to the lower link. However, in this arrangement, the spring can be extended beyond its safe point, especially when the support arm is brought to its highest vertical position or its lowest vertical position. The spring may exhibit non-linear characteristics when extended beyond its safe point. This may be evidenced by a sagging effect when the support arm is brought to its highest position, and a creeping effect when the support arm is brought to its lowest position. Moreover, repeated over-extension of the spring can ultimately result in spring fatigue or permanent spring deformation.

Parallelogram support arms utilizing mechanical springs are generally lighter, more compact, and less costly to manufacture and maintain than support arms featuring gas cylinders, without sacrificing strength and weight-load capacity. However, it would be advantageous for such a support arm to feature a mechanism preventing the over-extension of the spring, thereby allowing the spring to provide a near constant force throughout the support arm's range of motion while also reducing the likelihood of spring fatigue and deformation.

### II. SUMMARY

The invention disclosed herein is generally directed to an adjustable support arm for mounting an object such as a flat panel display, light source, or work surface. Other applications of the invention are also envisioned, as the invention can readily be used wherever a spring is used in conjunction with a parallelogram linkage.

The adjustable support arm of the present invention utilizes a spring having a dynamic attachment point to support the weight of the attached object. By utilizing a dynamic attachment point for one end of the spring instead of the traditional fixed attachment, the spring is capable of exerting a more uniform force throughout the arm's range of motion. Thus, the load capabilities of the adjustable support arm of the present invention will exhibit little variation as the arm is adjusted from its highest position to its lowest position. The dynamic attachment point feature also reduces the travel range of the spring, thereby reducing spring fatigue or permanent deformation of the spring.

An adjustable support arm having features of the present invention comprises a lower bracket and an upper bracket. A parallelogram linkage comprising an upper link and a lower link attaches the upper bracket to the lower bracket to form a four-bar linkage. The first end of the spring is attached to either the upper link or the lower bracket. The second end of the spring is attached to a drag link. The drag link's first end is attached to the upper bracket, while the drag link's second end is attached to the second end of the spring. A pivot link is also attached to the drag link's second end to guide the drag link's movement as the arm's vertical height is adjusted. The pivot link's first end is attached to the lower link, while the pivot link's second end is attached to the drag link's second end.

In another embodiment, the adjustable support arm can comprise a first pivot link and a second pivot link. The first pivot link can be pivotally attached to the left sidewall of the lower link, and the second pivot link can be pivotally attached to the right sidewall of the lower link. The second end of both the first and second pivot links are attached to the drag link to guide the drag link's movement as the arm's vertical height is adjusted.

Another embodiment of an adjustable support arm having features of the present invention comprises a lower bracket and an upper bracket. A parallelogram linkage comprising an upper link and a lower link attaches the upper bracket to the lower bracket to form a four-bar linkage. The first end of the spring is attached to either the upper link or the lower bracket. The second end of the spring is attached to a drag link. The drag link's first end is attached to the upper bracket, while the drag link's second end, which is attached to the spring, engages a slot in the lower link. One or more rollers can be used to attach the drag link to the slot in the lower link.

Another embodiment of an adjustable support arm having features of the present invention comprises a lower bracket and an upper bracket. A parallelogram linkage comprising an upper link and a lower link attaches the upper bracket to the lower bracket to form a four-bar linkage. A drag link is attached to the upper bracket at the drag link's first end. A spring is attached to either the upper link or the lower bracket at the spring's first end, while the spring's second end is attached to the drag link's second end. A means for guiding the movement of the drag link's second end as the support arm is raised and lowered is also featured.

The above summary is not intended to describe each illustrated embodiment or every possible implementation. These and other features, aspects, and advantages of the present invention will become better understood with regard to the following description, appended claims, and accompanying drawings.

### III. BRIEF DESCRIPTION OF THE DRAWINGS

FIG. 1 is a right perspective view of an embodiment of the adjustable support arm of the present invention.

FIG. 2 is a right-side perspective view of an embodiment of the adjustable support arm's arm assembly.

FIG. 3a is an exploded view of the embodiment of the arm assembly shown in FIG. 2.

FIG. 3b is another exploded view of the embodiment of the arm assembly shown in FIG. 2.

FIG. 4 is a right-side perspective view of the embodiment of the arm assembly shown in FIG. 2, wherein the upper link is removed to show the inner components.

FIG. 5 is a right-side view of the embodiment of the arm assembly shown in FIG. 2, wherein the arm assembly is in the raised position.

FIG. 6 is a right-side view of the embodiment of the arm assembly shown in FIG. 2, wherein the arm assembly is in the lowered position.

FIG. 7 is a right-side perspective view of an alternative embodiment of the adjustable support arm's arm assembly.

FIG. 8 is an exploded view of the embodiment of the arm assembly shown in FIG. 7.

FIG. 9 is a right-side view of the embodiment of the arm assembly shown in FIG. 7, wherein the arm assembly is in the raised position.

FIG. 10 is a right-side view of the embodiment of the arm assembly shown in FIG. 7, wherein the arm assembly is in the lowered position.

### IV. DESCRIPTION

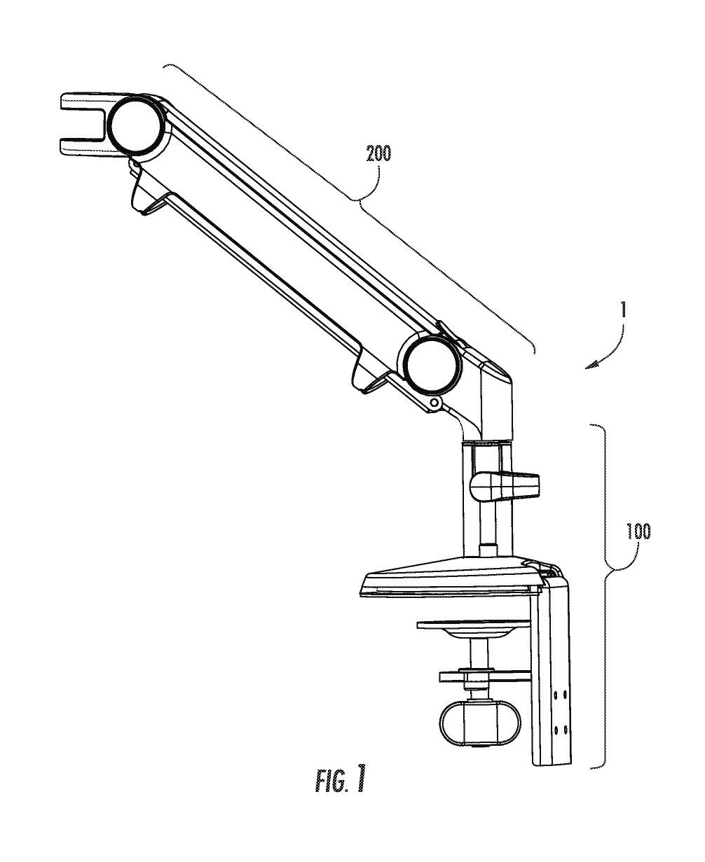

Referring to FIG. 1, the adjustable support arm 1 can comprise an arm assembly 200 connected to a base assembly 100. A mount assembly (not shown) can be attached to the arm assembly 200 for attaching an object such as a flat panel display, light source, or work surface to the adjustable support arm 1.

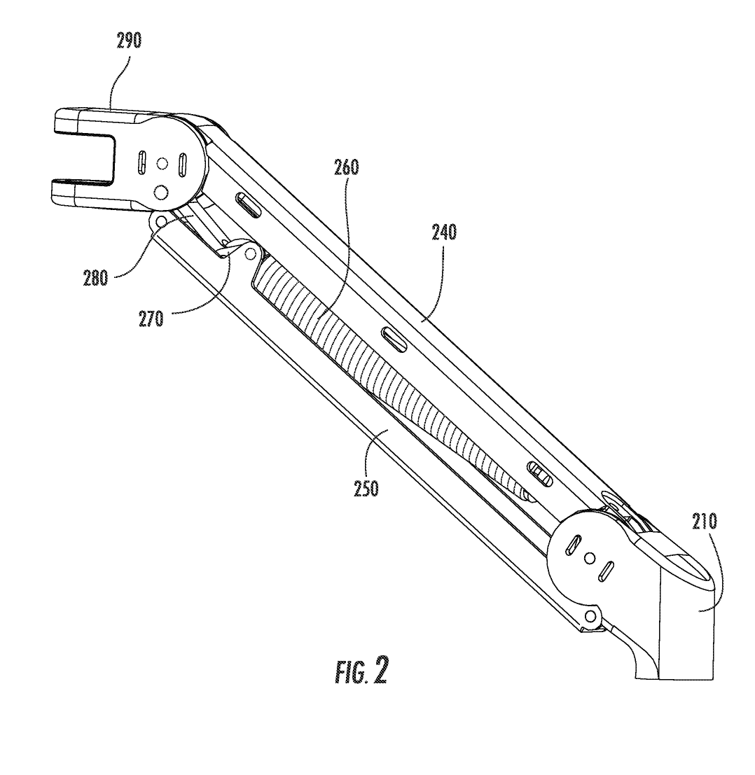

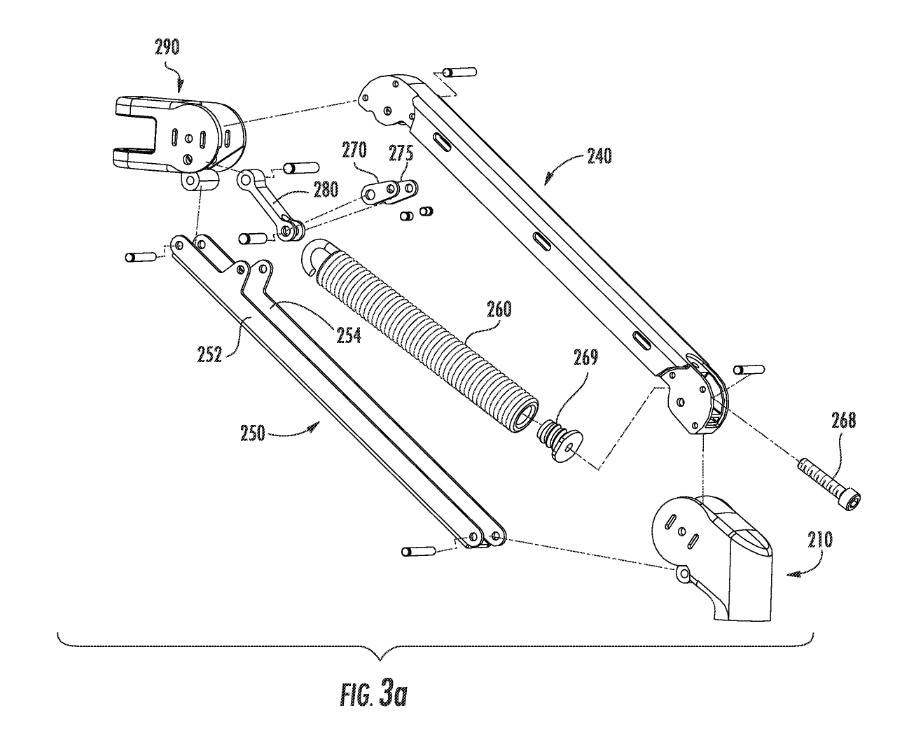

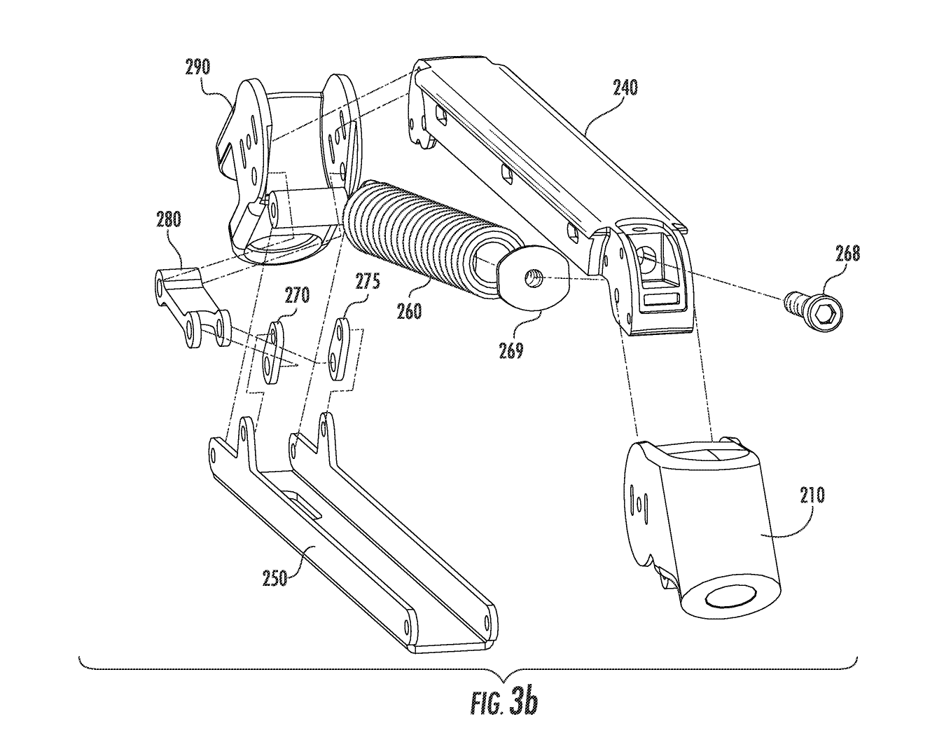

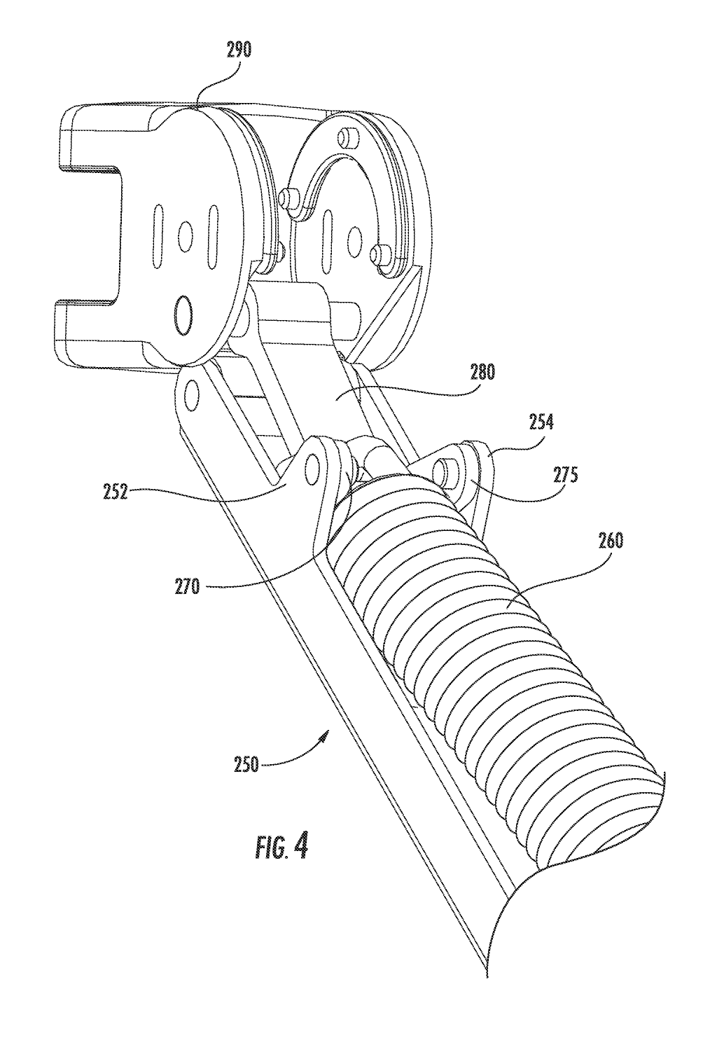

Referring to FIGS. 2-4, the arm assembly 200 can comprise a lower bracket 210, an upper link 240, a lower link 250, a spring 260, one or more pivot links 270, 275, a drag link 280, and an upper bracket 290. As shown in FIG. 1, the arm assembly 200 can also comprise right and left arm covers featuring one or more cable guides.

The upper link 240 and lower link 250 form a parallelogram linkage. The upper link 240's first end is pivotally attached to the lower bracket 210, and the upper link 240's second end is pivotally attached to the upper bracket 290. Similarly, the lower link 250's first end is pivotally attached to the lower bracket 210, and the lower link 250's second end is pivotally attached to the upper bracket 290. The upper and lower links 240, 250 can be attached to the upper and lower brackets 290, 210 with pins, bolts, or any other fasteners known in the art capable of allowing the upper and lower links to pivot about the attachment points.

A spring 260 can be utilized to support the weight of an attached object. In the embodiments depicted in FIGS. 1-10, the spring 260 is a helical extension spring. Spring 260's first end can be attached to the upper link 240 with a bolt 268 and a screw screw cap 269. The bolt 268 and screw cap 269 interact with the spring 260 to provide a preload adjustment feature for the arm assembly 200. The spring 260 exhibits thread-like features, allowing it to be threadingly engaged by screw cap 269's external threads. The shaft of bolt 268 extends through an aperture in upper link 240 to threadingly engage the screw cap 269's internal threads, while the head of bolt 268 abuts the upper link 240 to form a bearing surface. In this arrangement, the spring 260 can be preloaded by tightening the bolt 268. As the bolt 268 is tightened, the screw cap 269 is pulled along the length of the bolt 268 toward the bolt's head, thereby stretching the spring 260 and providing a preload: In alternative embodiments, the spring 260's first end can be attached to the upper link 240 with pins, bolts, or any other fasteners known in the art.

The drag link 280 and the pivot links 270, 275 interact to provide a dynamic attachment point for the second end of the spring 260. The first end of the drag link 280 is pivotally attached to the upper bracket 290, while the first ends of the pivot links 270, 275 are pivotally attached to the left and right sidewalls 252, 254 of the lower link 250. The second end of the drag link 280 is pivotally attached to the second ends of both the pivot links 270, 275 and the spring 260. In this arrangement, the pivot links 270, 275 will guide the drag link 280's motion as the arm assembly 200 is raised and lowered, thereby forming a dynamic (i.e., movable) attachment point for the spring 260.

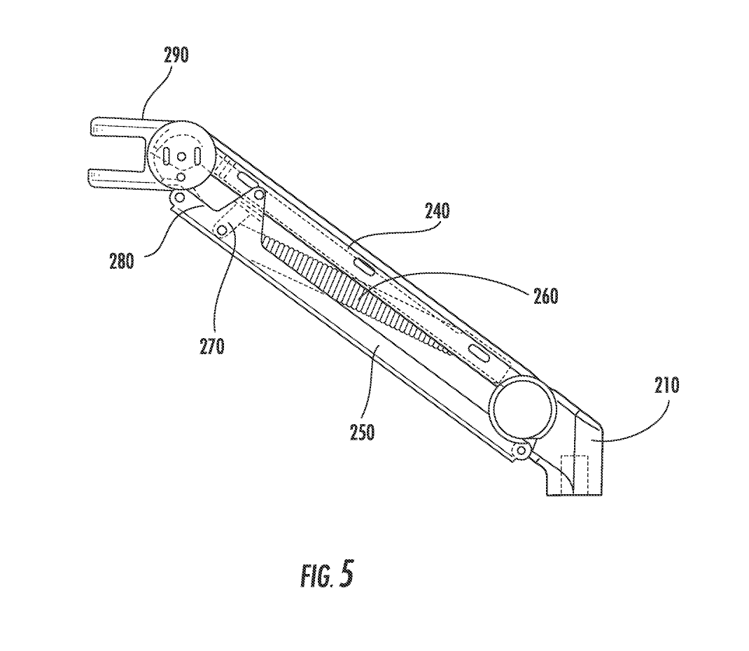

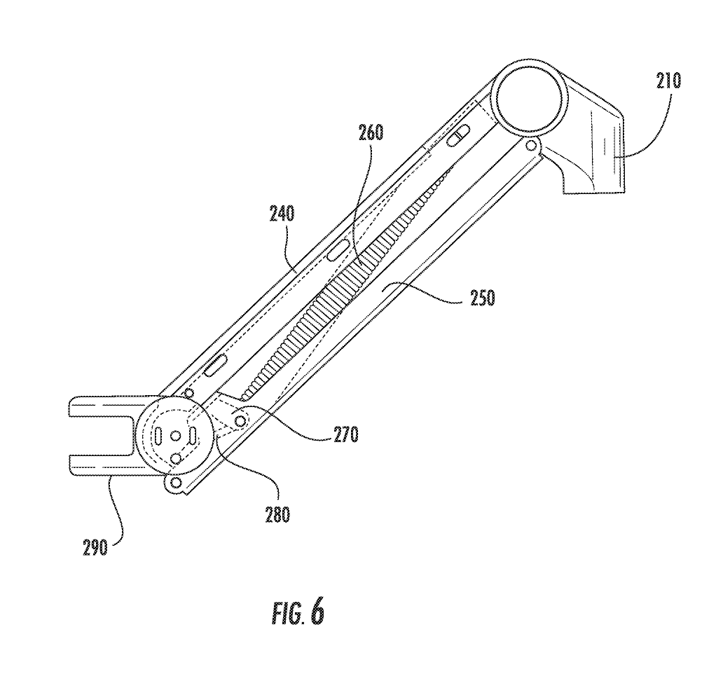

The dynamic spring attachment mechanism functions as follows. When the arm assembly 200 is brought to the raised position as depicted in FIG. 5, the drag link 280 pulls the second ends of the pivot links 270, 275. This pulling force causes the pivot links 270, 275 to pivot toward the upper bracket 290, which results in the attachment point for the spring 260 to be moved to a forward position relative to the lower link 250. Conversely, when the arm assembly 200 is brought to the lowered position as depicted in FIG. 6, the drag link 280 pushes the second ends of the pivot links 270, 275. This pushing force causes the pivot links 270, 275 to pivot away from the upper bracket 290, resulting in the attachment point for the spring 260 to be moved to a rearward position.

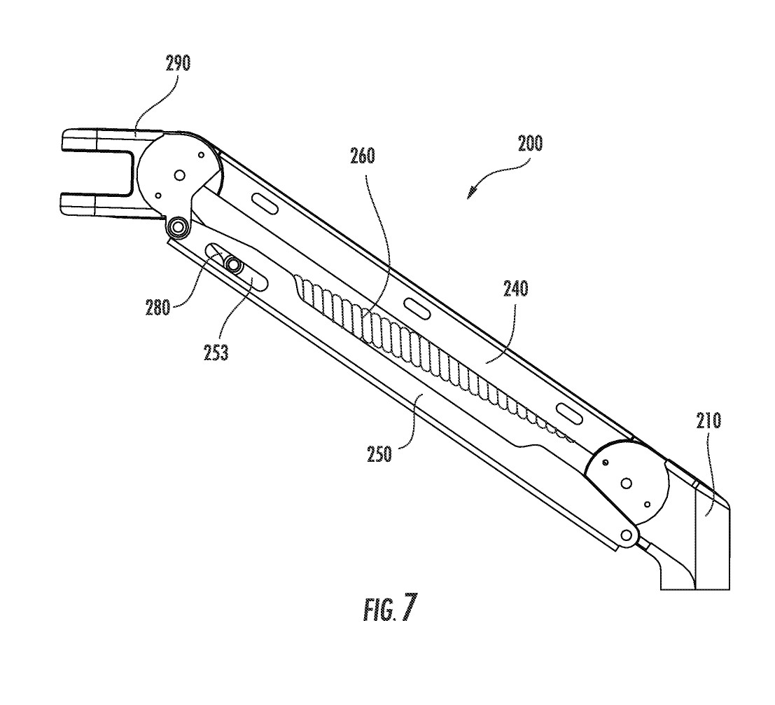

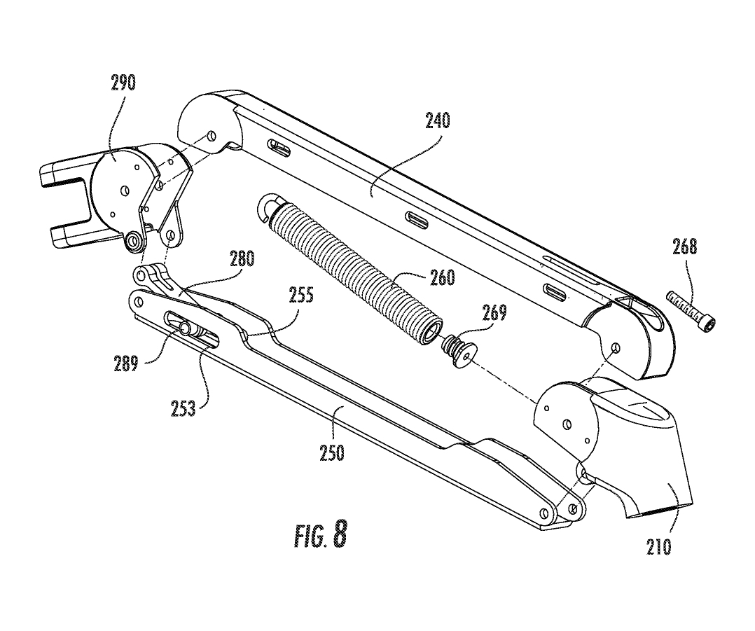

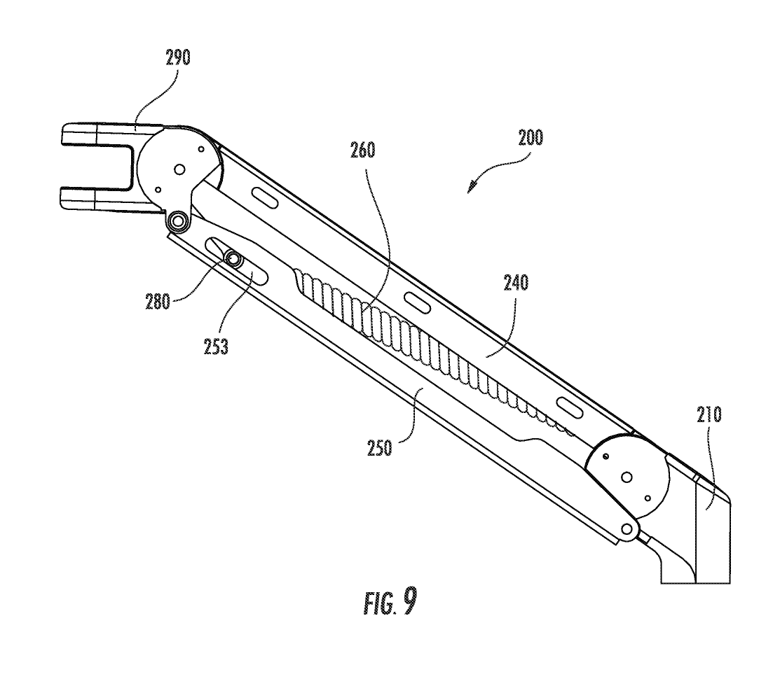

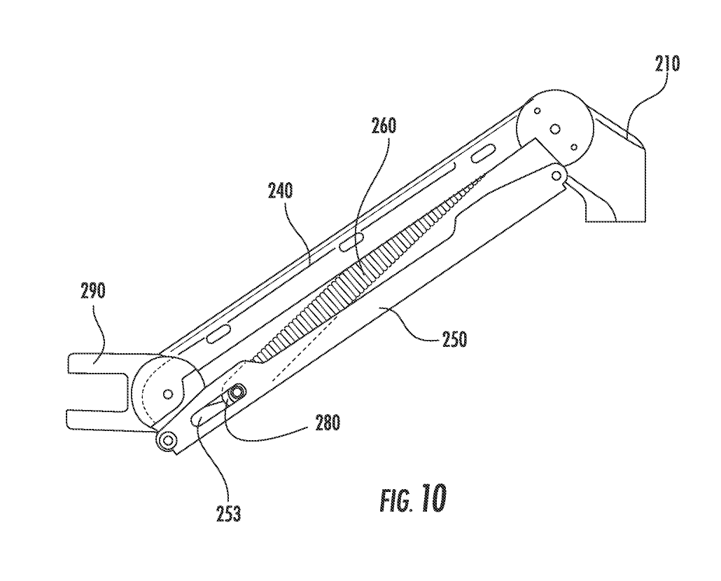

An alternative embodiment of the arm assembly 200 is depicted in FIGS. 7-10. Referring to FIGS. 7-8, the arm assembly 200 can comprise a lower bracket 210, an upper link 240, a lower link 250, a spring 260, a drag link 280, and an upper bracket 290. In this embodiment, the pivot links 270, 275 are replaced with one or more slots 253, 255 in the lower link 250. The drag link 280's second end operatively engages the slots 253, 255 via one or more rollers 289. Like the pivot links 270, 275, the slots 253, 255 will guide the drag link 280's motion as the arm assembly 200 is raised and lowered, thereby forming a dynamic attachment point for the spring 260. For instance, when the arm assembly 200 is brought to the raised position as depicted in FIG. 9, the attachment point for the spring 260 will be moved to a forward position on the slots 253, 355. Conversely, when the arm assembly 200 is brought to the lowered position as depicted in FIG. 10, the attachment point for the spring 260 will be moved to a rearward position on the slots 253, 355.

Many modifications and other embodiments of the inventions set forth herein will come to mind to one skilled in the art to which these inventions pertain having the benefit of the teaching presented in the foregoing descriptions and the associated drawings. For instance, one skilled in the art will appreciate that a compression spring could be used in place of the extension spring depicted in the attached figures. In such an embodiment, the first end of the compression spring would be attached to the upper bracket, with the second end being attached to the drag link. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An adjustable support arm comprising:
a. A lower bracket;
b. An upper bracket;
c. A parallelogram linkage attaching the upper bracket to the lower bracket, the parallelogram linkage comprising an upper link and a lower link;
d. A pivot link having a first end and a second end, the pivot link's first end pivotally attached to the lower link;
e. A drag link having a first end and a second end, wherein the drag link's first end is pivotally attached to the upper bracket and the drag link's second end is pivotally attached to the pivot link's second end; and
f. A spring attached to the drag link.

2. The adjustable support arm of claim 1, wherein the spring defines a first end and a second end, wherein the spring's first end is attached to the upper link and the spring's second end is attached to the drag link.

3. The adjustable support arm of claim 2, further comprising a means for applying a preload to the spring.

4. The adjustable support arm of claim 3, wherein the means for applying a preload to the spring comprises:
a. a screw cap having internal threads and external threads, the screw cap's external threads being threadingly engaged to the spring's first end; and
b. a bolt extending through an aperture in the upper link to threadingly engage the screw cap's internal threads.

5. The adjustable support arm of claim 2, wherein the spring is an extension spring.

6. The adjustable support arm of claim 1, further comprising a second pivot link having a first end and a second end, wherein the first end of the second pivot link is pivotally attached to the lower link and the second end of the second pivot link is pivotally attached to the drag link's second end.

7. The adjustable support arm of claim 6, wherein lower link defines a left sidewall and a right sidewall, wherein the first end of the first pivot link is pivotally attached to the left sidewall and the first end of the second pivot link is pivotally attached to the right sidewall.

8. The adjustable support arm of claim 1, further comprising a base assembly attached to the lower bracket and a mount assembly attached to the upper bracket.

9. An adjustable support arm comprising:
a. A lower bracket;
b. An upper bracket;
c. A parallelogram linkage attaching the upper bracket to the lower bracket, the parallelogram linkage comprising an upper link and a lower link;
d. A drag link having a first end and a second end, the first end pivotally attached to the upper bracket, the second end engaging a slot in the lower link; and
e. A spring attached to the drag link.

10. The adjustable support arm of claim 9, wherein the spring defines a first end and a second end, wherein the spring's first end is attached to the drag link and the spring's second end is attached to the upper link.

11. The adjustable support arm of claim 10, further comprising a means for applying a preload to the spring.

12. The adjustable support arm of claim 11, wherein the means for applying a preload to the spring comprises:
a. a screw cap having internal threads and external threads, the screw cap's external threads being threadingly engaged to the spring; and
b. a bolt extending through an aperture in the upper link to threadingly engage the screw cap's internal threads.

13. The adjustable support arm of claim 10, wherein the spring is an extension spring.

14. The adjustable support arm of claim 9, further comprising one or more rollers attached to the drag link for engaging the slot in the lower link.

15. The adjustable support arm of claim 14, further comprising a base assembly attached to the lower bracket and a mount assembly attached to the upper bracket.

16. An adjustable support arm comprising:
a. A lower bracket;
b. An upper bracket;
c. A parallelogram linkage attached the upper bracket to the lower bracket, the parallelogram linkage comprising an upper link and a lower link;
d. A drag link having a first end and a second end, the drag link's first end pivotally attached to the upper bracket;
e. A spring attached to the drag link; and
f. A means for guiding the movement of the drag link's second end as the adjustable support arm is raised and lowered.

17. The adjustable support arm of claim 16, wherein the means for guiding the movement of the drag link's second end comprises a pivot link, the pivot link having a first end attached to the lower link and a second end pivotally attached to the drag link.

18. The adjustable support arm of claim 16, wherein the means for guiding the movement of the drag link's second end comprises a slot in the lower link operatively engaged by the drag link's second end.

19. The adjustable support arm of claim 16, further comprising a base assembly attached to the lower bracket and a mount assembly attached to the upper bracket.

20. The adjustable support arm of claim 16, further comprising a means for applying a preload to the spring, wherein the means for applying a preload to the spring comprises:
a. a screw cap having internal threads and external threads, the screw cap's external threads being threadingly engaged to the spring; and
b. a bolt extending through an aperture in the upper link to threadingly engage the screw cap's internal threads.
